(19) United States
(12) Patent Application Publication
(10) Pub. No.: US 2025/0227539 A1
(43) Pub. Date: Jul. 10, 2025

(54) Multi-Packet Acknowledgment

(71) Applicant: TEXAS INSTRUMENTS INCORPORATED, Dallas, TX (US)

(72) Inventors: Yaron Alpert, Hod Hasharon (IL); Maxim Altshul, Kadima (IL); Inbal Farchy, Beer-Sheva (IL)

(21) Appl. No.: 18/409,541

(22) Filed: Jan. 10, 2024

(51) Int. Cl. H04W 28/02; H04L 47/2466

(52) U.S. Cl. CPC H04W 28/0236; H04L 47/2466

(57) ABSTRACT

A method may include a wireless device being able to switch between acknowledgment modes. A first acknowledgment mode may employ one acknowledgment packet per data packet, and a second acknowledgment mode may employ a multi-packet acknowledgment so that multiple packets may be acknowledged at a time. The wireless device may select one or the other acknowledgment mode based on, e.g., communication link quality.

### TECHNICAL FIELD

The present disclosure relates generally to electronic systems and methods, and, in some embodiments, to multi-packet acknowledgment.

### BACKGROUND

Bluetooth (BT) and Bluetooth Low Energy (BLE) are examples of communication protocol standards that facilitate wireless data transmission over a radio link. Various applications include a BLE master or central device (a “central”) that maintains wireless communication links with multiple BLE slave or peripheral devices (each a “peripheral”).

During wireless communication, channel state may change, position of devices may change, and those various changes may cause data packets to be lost. Accordingly, BT and BLE employ acknowledgment procedures for a receiving device to acknowledge receipt of a data packet and to alert a transmitting device when retransmission of a lost packet is appropriate.

### SUMMARY

In one embodiment, a method includes: receiving, at a first device, a first plurality of packets from a second device; acknowledging, by the first device, the first plurality of packets, including transmitting to the second device a first plurality of acknowledgment packets, one acknowledgment packet per data packet; determining that a triggering event has occurred; and negotiating to perform multi-packet acknowledgment between the first device and the second device in response to the triggering event.

In another embodiment, a method includes: transmitting, from a first device, a first plurality of packets to a second device; receiving, by the first device, a first plurality of acknowledgment packets, one acknowledgment packet per data packet, from the second device; determining that a triggering event has occurred; and negotiating to perform multi-packet acknowledgment between the first device and the second device in response to the triggering event.

In yet another embodiment, an electronic device includes a transducer configured to communicate via a wireless network and a processor configured to: operate in a per-packet acknowledgment mode in which the processor transmits, using the transducer, an acknowledgement packet per packet received; and switch from the per-packet acknowledgment mode to a multi-packet aggregated acknowledgment mode in which the processor transmits, using the transducer, an acknowledgment packet to acknowledge multiple packets received.

### BRIEF DESCRIPTION OF THE DRAWINGS

Having thus described the invention in general terms, reference will now be made to the accompanying drawings, wherein:

FIG. 1 is an illustration of two example wireless communication devices, which may perform multi-packet acknowledgment, according to various embodiments.

FIG. 2 is an illustration of an example data packet and an example acknowledgment packet, according to various embodiments.

FIGS. 3-10 are illustrations of example time domain operations, including multi-packet acknowledgment, according to various embodiments.

FIG. 11 is an illustration of an example data packet, which may be transmitted during negotiation between wireless devices, according to various embodiments.

FIG. 12 is an illustration of an example acknowledgment and retransmission, according to various embodiments.

FIG. 13 is an illustration of an example acknowledgment and retransmission, according to various embodiments.

FIGS. 14 and 15 are illustrations of example methods for switching between acknowledgment modes, according to various embodiments.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Embodiment of the present disclosure are described in specific contexts, e.g., a multi-packet acknowledgement system and method for using in BT or BLE communications. Some embodiments may be used in other communication protocols, such as some proprietary or standard-based wireless protocols. Some embodiments may be used in wired communication protocols, such as power line communication (PLC) protocols, wired networking protocols, or other serial or parallel wired communication protocols.

In an embodiment, a device includes a multi-packet acknowledgement mode, in which multiple received packets are acknowledged with a single acknowledgement packet instead of acknowledging each packet independently. In some embodiments, the number of packets to be acknowledged is negotiated during a negotiation phase, which may occur before a data exchange, during a data exchange, and/or upon a device joining a network. In some embodiments, the device may operate using a per-packet acknowledgement mode by default, and may (e.g., dynamically) switch to the multi-packet acknowledgement mode in response to a trigger, where the trigger may be based on a request from an application running at the host, a quality of a communication link, and/or based on some other metric not related to the quality of the communication link.

In some embodiments, the characteristics of the multi-packet acknowledgement mode (e.g., number of packets to be acknowledged, format of acknowledgement, etc.) may be dynamically adjusted, e.g., based on a request from an application running at the host, a quality of a communication link, and/or based on some other metric not related to the quality of the communication link.

In Bluetooth Low Energy (BLE) standard, the per-packet acknowledgment (Ack) mechanism works as follows. When side A sends over the air a (e.g., data or control) packet, side B may reply either with an encapsulated (e.g., data) packet of its own or with a non-encapsulated packet, also known as an Empty Packet. Both, the encapsulated packet and the non-encapsulated packet serve as an Ack packet. The encapsulated packet has a non-empty payload. The Empty Packet has no data as part of the payload and is actually the Ack packet, which is indicated in the packet header. In BLE, between each packet, there is a known, typically 150 us period, known as negotiable inter-frame spacing (T_IFS), which is used to allow the device time to switch the associated RF and analog circuits between transmission and reception, e.g., and possibly to allow the device antenna to cool down to keep the operating frequency as tight as possible. In BLE, the data or control packets may include layer 2 packets transmitted over the air.

With inter-frame spacing acting as a constraint, and with a maximum data size of a packet of 251 bytes acting as another constraint, maximal throughput of BLE with a 2-megabit physical layer may be calculated as follows. Transmit time 1060 us (251B)+150 μs (T_IFS)+40 μs (10B ACK)+150 μs (T_IFS)=1400 μs. As a result, the maximum throughput of BLE is around 1.4 Mbps (˜180 Kbytes/sec) when using a 2-megabit physical layer (2M PHY). The inter-frame spacing and maximum data size may also impact availability and delay in some applications, such as those that are bi-directional.

Such maximum throughput may be appropriate for some applications, but other applications and future uses of BLE may benefit from higher throughput. For instance, the Connected Car Consortium (CCC) proposes features that may benefit from higher throughput. For example, the Channel Sounding (CS) feature proposes transferring more than 2.5 kB of data from a reflector device to an initiator device in a single CS exchange, followed by subsequent CS exchanges until satisfactory range is achieved. In some examples, the CS feature may benefit from higher throughput, as higher throughput allows faster exchanges of the CS data and, thus, faster range identification.

Various implementations include a multi-packet acknowledgment mode to reduce overhead and increase efficiency in some situations. An example embodiment includes an acknowledgment response for multiple (e.g., data or control) packets and an ability to send a configurable amount of (e.g., data or control) packets without receiving an immediate acknowledgment. For instance, some embodiments may allow for negotiation of a quantity of packets to be acknowledged in a single (e.g., aggregated) acknowledgment. In some embodiments, retransmission and signaling are available in the event that a data packet is lost. Furthermore, some embodiments allow for a transmitter to request an immediate multi-packet acknowledgment, even when a negotiated quantity of packets have not yet been transmitted.

Various implementations may include multiple acknowledgment modes that may be used as appropriate. For instance, one implementation includes operating in a first per-packet acknowledgment mode in which a device transmits one acknowledgment packet per received data packet. The implementation may further include operating in a second multi-packet acknowledgment mode in which the device transmits an acknowledgment packet to acknowledge multiple received packets.

In some embodiments, the device may switch from the first mode to the second mode during operation. For instance, in one implementation, the device operates in the first mode (e.g., per-packet acknowledgement mode). During operation, the device may determine a quality of a communication link and then negotiate to operate in the second mode (e.g., multi-packet acknowledgement mode) based on the communication link quality being higher than a threshold. For instance, when the link quality is lower, per-packet acknowledgment may be appropriate in some instances, whereas when the link quality is higher, multi-packet acknowledgment may be appropriate.

An advantage of some embodiments includes increased throughput and reduced response time. In one example, the devices may negotiate that 10 packets may be acknowledged with a single acknowledgment, thereby reducing a number of acknowledgments by 90%. When compared to an implementation that uses a one acknowledgment per packet mode, the multi-packet acknowledgment mode may increase throughput by around 15%, assuming a maximum protocol data unit (PDU) size of 251 bytes and an acknowledgment packet size of 10 bytes.

Yet another advantage of some embodiments is that inter-frame spacing may be reduced or eliminated, with multiple packets being acknowledged together. For instance, devices may negotiate that 10 packets may be acknowledged with a single acknowledgment, thereby allowing 10 packets to be sent with a reduced or eliminated inter-frame spacing. The inter-frame spacing may be considered overhead and, thus, reduction of inter-frame spacing may increase maximal throughput. An increase in maximal throughput may advantageously lead to more and different practical uses of BLE, such as in automotive applications.

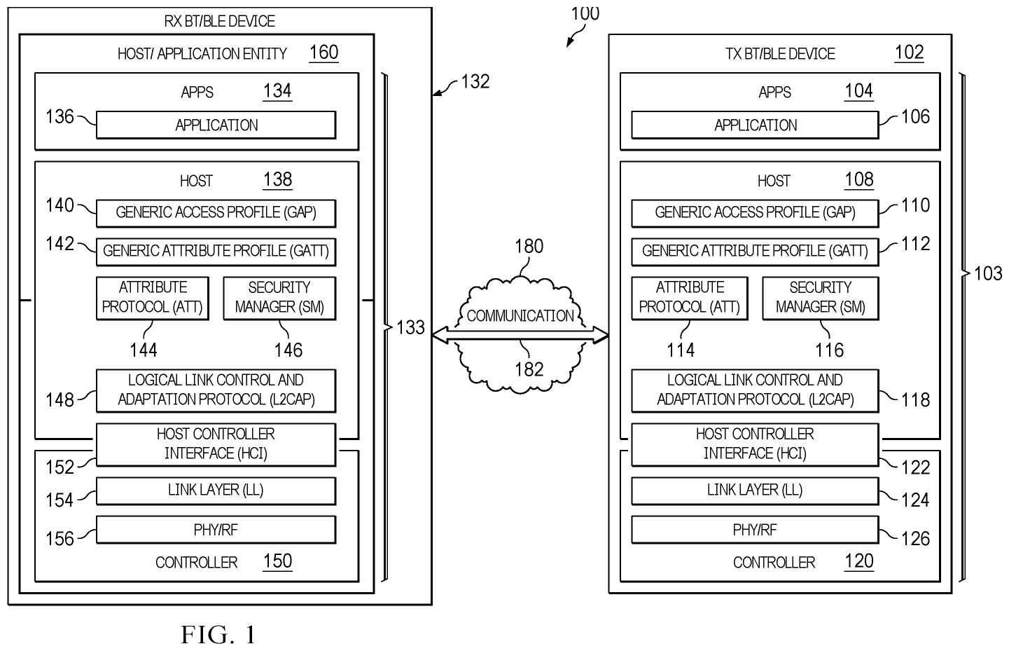

FIG. 1 is an illustration of an example first Bluetooth (BT) or Bluetooth Low Energy (BLE) device 132 and a second BT/BLE device 102, according to various embodiments. For instance, example devices 132 and 102 may include functionality in their link layers 154, 124 to operate in at least two acknowledgment modes-a first acknowledgment mode (e.g., per-packet acknowledgment) and a second acknowledgment mode (e.g., multi-packet acknowledgment). In one example, device 102 may be physically implemented as circuits on a first semiconductor device, and device 132 may similarly be physically implemented as circuits on a second semiconductor device. Each of the devices 102, 132 may be included in separate semiconductor packages as appropriate.

In the present example, both devices 132 and 102 are capable of transmitting and receiving. The BT/BLE device 132 (e.g., a key fob, a wearable device, a smartphone, a sensor, an in-vehicle component, or other device with BT/BLE functionality) is in communication with the BT/BLE device 102 (e.g., another key fob, a wearable device, a smartphone, a sensor, an in-vehicle component, or other device with BT/BLE functionality) via wireless communication channels 180. Wireless communications 182 are received by the BT/BLE device 132 and transmitted from the BT/BLE device 102 (and vice versa) via the wireless communication channels 180.

The BLE standard defines a hierarchy of layers and components to be implemented by each electronic device to support low-power wireless communications. The bottom layer defined by the BLE standard is the BLE controller 120, 150, which includes the physical (PHY) layer and a radio frequency (RF) layer 126, 156. The RF layer may include a transducer, such as a transceiver, to send and receive RF signals under control of the controller 120, 150. Above the BLE controller is the BLE host 108, 138. Above the BLE host layer 108, 138 resides the application layer 104, 134 with applications 106, 136 configured to send or receive data via the BLE host layer and BLE controller layer. In BLE, communication channels include data channels and advertisement channels. In some embodiments, the devices 102, 132 communicate using data channels. In BLE, each data channel has a unique band between 2.4 GHz and 2.4835 GHz, and each of those channels has unique frequency-dependent characteristics.

In the example of FIG. 1, the BT/BLE device 102 includes a BT/BLE stack 103 with an application layer 104, a host layer 108, and a controller layer 120. The application layer 104 includes one or more applications 106 executed by the BT/BLE device 102. The host layer 108 includes a generic access profile (GAP) 110, a generic attribute profile (GATT) 112, an attribute protocol (ATT) 114, a security manager (SM) 116, and a logic link control and adaptation protocol (L2CAP) 118. The controller layer 120 includes a link layer (LL) 124 and PHY/RF layers 126. In some example embodiments, the BT/BLE device 102 uses dedicated signaling (e.g., API signaling) referred to as host controller interface (HCI) 122 to communicate between the host layer 108 and the controller layer 120.

The BT/BLE device 132 includes a BT/BLE stack 133 with an application layer 134, a host layer 138, and a controller layer 150. The application layer 134 includes one or more applications 136 executed by the RX BT/BLE device 130. The host layer 138 includes GAP 140, GATT 142, ATT 144, SM 146, and L2CAP 148. The controller layer 120 includes LL 154 and PHY/RF layers 156. In some example embodiments, the RX BT/BLE device 130 uses dedicated signaling (e.g., API signaling) referred to as HCI 152 to communicate between the host layer 138 and the controller layer 150. In some example embodiments, the application layer 134 and/or the host layer 138 are in communication with a host/application entity 160.

Various implementations described herein may be symmetrical with respect to a peripheral device and a central device. For instance, in a BLE scenario, such as which is illustrated in FIG. 1, the central device and peripheral device may play distinct roles in facilitating efficient and low-power data exchange. For example, the central device typically assumes the role of overseeing and managing the communication process. In some examples, the central device initiates connections, controls data transmission intervals, and coordinates communication with one or more peripheral devices. In some examples, peripheral devices respond to the requests from the central device and transmit data as needed. Peripheral devices may be designed to be power-efficient, often operating in a sleep mode and waking up only when necessary to conserve energy. This central-peripheral relationship allows for a flexible and energy-efficient network configuration, making BLE technology appropriate for some applications such as wearable devices, smart sensors, and other Internet of Things (IoT) implementations where low power consumption is beneficial.

In the examples herein, either one of the devices 102, 132 may be a central device or a peripheral device, and either one of the devices 102, 132 may measure a data channel, begin a negotiation to switch an acknowledgment mode, respond and/or participate in a negotiation to switch an acknowledgment mode, respond to a measurement of a data channel, acknowledge reception positively or negatively, perform retransmission, and the like.

The acknowledgment functionalities described herein may be performed by software, firmware, or hardware logic. For instance, in some example embodiments, the actions to perform acknowledgment, switch acknowledgment modes, negotiate, and/or the like may be performed by a processing device (e.g., either of controllers 120, 150) executing computer-readable code.

In some embodiments, controller 120 may be implemented with a generic or custom processor or controller, e.g., capable of executing instructions stored in an associated memory. In some embodiments, controller 120 may be implemented in hardware using state machines. Other implementations are also possible.

In some embodiments, controller 150 may be implemented with a generic or custom processor or controller, e.g., capable of executing instructions stored in an associated memory. In some embodiments, controller 150 may be implemented in hardware using state machines. Other implementations are also possible.

In some embodiments, host 108 may be implemented with a generic or custom processor or controller, e.g., capable of executing instructions stored in an associated memory. In some embodiments, host 108 may be implemented in hardware using state machines. Other implementations are also possible.

In some embodiments, host 138 may be implemented with a generic or custom processor or controller, e.g., capable of executing instructions stored in an associated memory. In some embodiments, host 108 may be implemented in hardware using state machines. Other implementations are also possible.

In some embodiments, host 108 and 120 may be combined and may be implemented using, e.g., a single, e.g., generic or custom processor or controller, e.g., capable of executing instructions stored in an associated memory.

In some embodiments, host 138 and controller 150 may be combined and may be implemented using, e.g., a single, e.g., generic or custom processor or controller, e.g., capable of executing instructions stored in an associated memory.

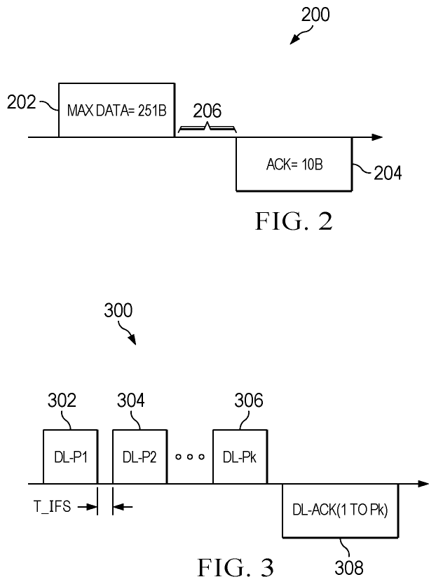

FIG. 2 is an illustration of an example time domain operation 200 in a per-packet acknowledgment mode, according to various embodiments.

Time domain operation 200 includes a data packet 202, which may be transmitted by a first device (e.g., one of devices 102, 132) and received by a second device (e.g., the other of devices 102, 132). In this example, the data packet 202 has 251 bytes, and it takes 1060 μs to transmit. There is a gap 206 between the data packet 202 and its corresponding acknowledgment packet 204.

In this example, the acknowledgment packet 204 is transmitted by the second device in response to receiving data packet 202. In this example, acknowledgment packet 204 is an empty packet, which includes an appropriate header, cyclic redundancy check (CRC) content, and a payload that has no data. In BLE, an empty packet is 10 octets or 10 bytes and may take 40 μs to transmit.

FIG. 2 illustrates an explicit acknowledgment scenario. In another scenario, the first device may transmit the data packet 202, and the second device may acknowledge receipt of data packet 202 by transmitting another data packet to the first device. In such a scenario, successful reception of the data packet 202 is implied by transmission of the second data packet by the second device.

While the example of FIG. 2 provides specific numbers for quantity of bytes and transmit times, it is noted that the scope of implementations is not limited to the specific numbers in FIG. 2. Rather, the scope of implementations may include any appropriate data packet or acknowledgment packet.

FIG. 3 is an illustration of an example time domain operation 300, according to various embodiments. In the example of FIG. 3, the acknowledgment mode is a multi-packet acknowledgment mode.

Operation 300 assumes that the devices have negotiated to determine a quantity of packets to be acknowledged with a single acknowledgment packet. In this example, the quantity of packets is k, which is an integer larger than one. The k packets are illustrated as packets 302-306.

The k packets are sent on the downlink (DL) by a first device to a second device. The second device sends acknowledgment packet 308 on the uplink (UL). The acknowledgment packet 308 acknowledges, either positively or negatively, each of the packets 1 to k. In one example, the acknowledgment packet may include a payload having a bitmap, where each of the bits in the bitmap (e.g., based on the associated index of the bitmap) corresponds to a respective one of the packets 302-306. For example, a zero in the bitmap may represent a packet loss, whereas a one in the bitmap may represent a successfully received packet.

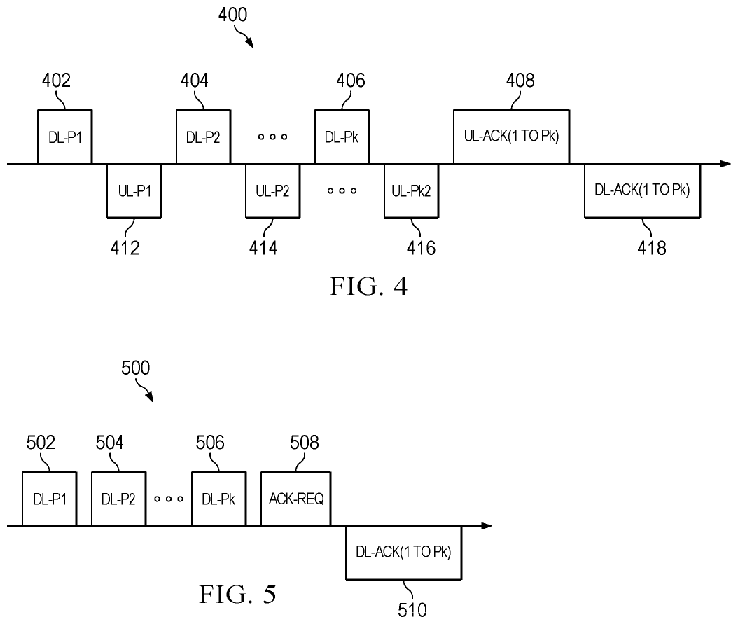

Continuing with the example, each of the packets 302-306 may include a unique identifier, such as an index, where each bit in the bitmap corresponds to an index. In another example, the packets 302-306 may be not numbered, and the acknowledgment packet 308 may simply identify a quantity of successfully received packets. The same is true of the other examples in FIGS. 4-15, that is, that multi-packet acknowledgment may include uniquely identified packets and a bitmap and/or an indication of a quantity of successfully-received packets. In some embodiments, the multi-packet acknowledgement may indicate that no packets were lost/corrupted or that at least 1 packet was lost/corrupted, without providing further indication on the number of packets lost/corrupted.

Additionally, the acknowledgment packet 308 may have a different structure than the acknowledgment packet 204. For instance, whereas the acknowledgment packet 204 includes a header, CRC content, and an empty payload, acknowledgment packet 308 may include a header and enough data in the payload to, e.g., include a bitmap and/or provide another acknowledgement indication, such as the number of packets being acknowledged, etc. As a result, acknowledgment packet 204 may be of a different (e.g., smaller) size than acknowledgment packet 308.

FIG. 4 is an illustration of an example time domain operation 400, according to various embodiments. In the example of FIG. 4, the acknowledgment mode is a multi-packet acknowledgment mode.

Operation 400 is similar to the operation 300 of FIG. 3, but operation 400 provides explicit acknowledgment for both DL packets 402-406 and UL packets 412-416 using packets 418, and 408, respectively. In some embodiments, the devices have negotiated to determine a quantity of packets to be acknowledged within a single acknowledgment packet. Accordingly, the second device transmits acknowledgment packet 418 to acknowledge packets 402-406, and the first device transmits acknowledgment packet 408 to acknowledge packets 412-416 (not necessarily in the order illustrated in FIG. 4).

In some embodiments, the negotiated quantity of data packets to be acknowledged may be different for the UL than for the DL.

In some instances, data packet 412 would be used implicitly to acknowledge data packet 402, as would data packet 404 acknowledge data packet 412 and on and on. However, some implementations may use a bit field in a data packet to indicate implicit acknowledgment, and the multi-packet acknowledgment of FIG. 4 may allow for that bit field to be used for another purpose.

FIG. 5 is an illustration of an example time domain operation 500, according to various embodiments. In the example of FIG. 5, the acknowledgment mode is a multi-packet acknowledgment mode.

In the example of FIG. 5, the devices have negotiated to determine a quantity N of packets to be acknowledged in a single data packet. Furthermore, that quantity N of packets is larger than k. The first device transmits packets 502-506 (k packets total). However, rather than waiting until N total packets have been transmitted in the transaction, the first device transmits an early acknowledgment request packet 508. The acknowledgment request packet 508 causes the second device to return acknowledgment packet 510 to acknowledge, either positively or negatively, the k packets 502-506.

In some embodiments, the acknowledgment request packet 508 may advantageously allow a device to request an immediate acknowledgment, regardless of a negotiated quantity of packets for multi-packet acknowledgment.

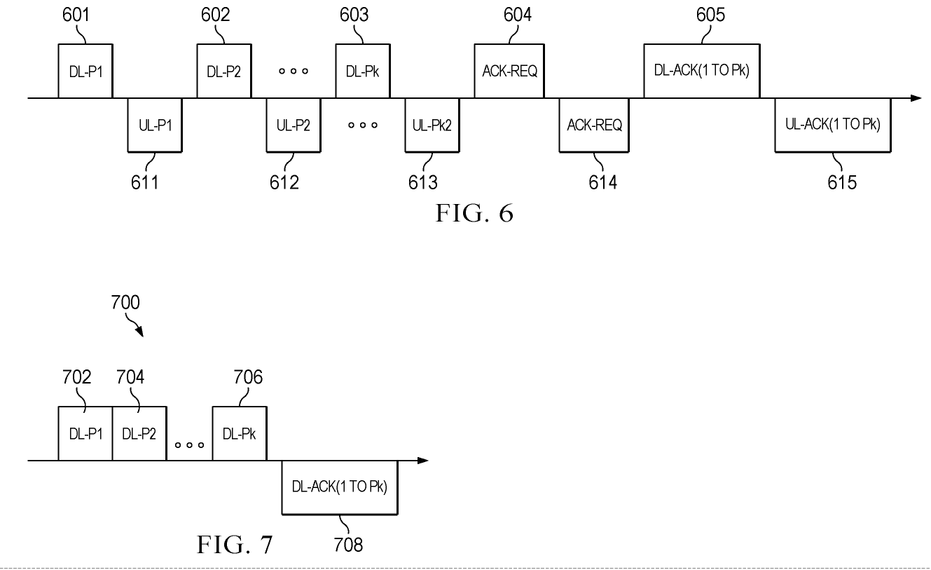

FIG. 6 is an illustration of an example time domain operation 600, according to various embodiments. In the example of FIG. 6, the acknowledgment mode is a multi-packet acknowledgment mode.

Operation 600 is similar to operation 500 of FIG. 5, but operation 600 includes acknowledgment requests for both the DL packets 601-603 and the UL packets 611-613. Specifically, the first device sends acknowledgment request packet 604 after having sent k packets 601-603, and the second device sends acknowledgment packet 615 in response. Acknowledgment packet 615 acknowledges k packets 601-603, where once again k is smaller than N. Similarly, acknowledgment packet 605 is transmitted in response to acknowledgment request 614, and acknowledgment packet 605 acknowledges k data packets 611-613. In some embodiments, as illustrated in FIG. 6, the acknowledgement requests packets from the central and peripheral devices may occur adjacent in time. In some embodiments, the acknowledgement requests packets may occur at any time, may or may not be adjacent in time to another acknowledgement request packet, and may be transmitted by only one (e.g., central or peripheral) of the devices, or both.

In some embodiments, the negotiated quantity of data packets to be acknowledged may be different for the UL than for the DL.

As in the example of FIG. 4, operation 600 may advantageously dispense with implicit acknowledgment and reuse the implicit acknowledgment bit field in the data packets for a different purpose.

FIG. 7 is an illustration of an example time domain operation 700, according to various embodiments. In the example of FIG. 7, the acknowledgment mode is a multi-packet acknowledgment mode.

Operation 700 is similar to operation 300 of FIG. 3, but operation 700 omits the inter-frame spacing (T_IFS). In the example operation 700, the devices may negotiate for multi-packet acknowledgment mode and may also negotiate for omission of inter-frame spacing. In these examples, the omission of inter-frame spacing may also be referred to as aggregated packets. Continuing with the example, the first device and the second device have negotiated to determine that the quantity of packets to be acknowledged in a single acknowledgment packet is k. The first device transmits k data packets 702-706. In response, the second device transmits acknowledgment packet 708, which acknowledges k data packets 702-706.

An advantage of embodiments employing aggregated packets may include further increased throughput. For instance, inter-frame spacing may be considered overhead in which no data is transmitted, and it is sometimes used as a way to allow radio frequency (RF) front end hardware, such as antennas, to maintain operating temperature. Maintaining operating temperature may help to ensure precise operation of the RF front end hardware, such as by reducing or eliminating frequency drift. However, advances in RF front end hardware may reduce or eliminate a need for inter-frame spacing, at least in some devices. Therefore, using aggregated packets, including omitting inter-frame spacing, may advantageously allow some devices to take advantage of better-quality hardware through higher throughput.

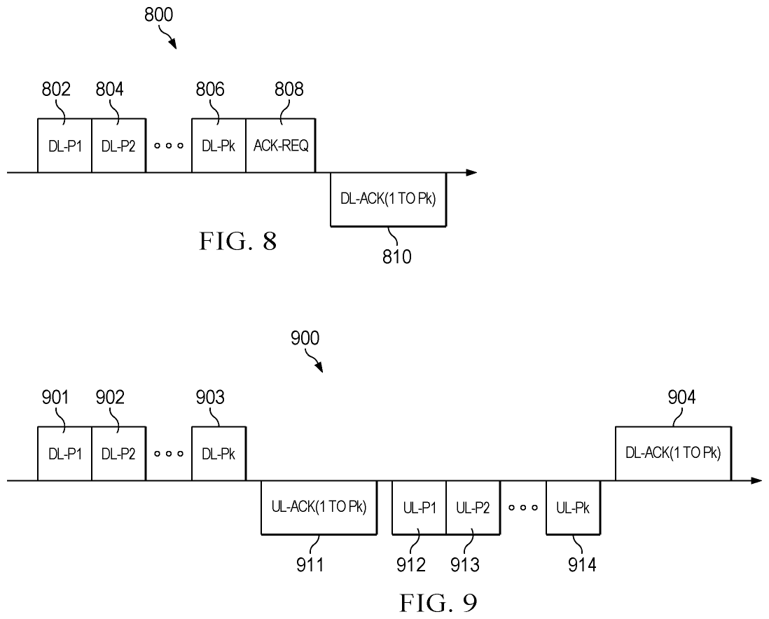

FIG. 8 is an illustration of an example time domain operation 800, according to various embodiments. In the example of FIG. 8, the acknowledgment mode is a multi-packet acknowledgment mode. More specifically, the example of FIG. 8 includes aggregated packets, as illustrated by data packets 802-806, which do not include inter-frame spacing.

In this example, the first device and the second device have negotiated to determine N as the quantity of packets to be acknowledged in a single acknowledgment packet, where N is larger than k. However, after transmitting k data packets, the first device transmits acknowledgment request packet 808. Acknowledgment request packet 808 instructs the second device to transmit acknowledgment packet 810 for data packets 802-806, even though a total of N packets has not yet been transmitted in this transaction by the first device.

FIG. 9 is an illustration of an example time domain operation 900, according to various embodiments. In the example of FIG. 9, the acknowledgment mode is a multi-packet acknowledgment mode. Furthermore, while operation 900 is illustrated using aggregated packets, some embodiments may include performing the same type of acknowledgment while including inter-frame spacing. As noted above, inter-frame spacing may or may not be negotiated separately from the negotiations for acknowledgment mode.

As shown in FIG. 9, the first device transmits data packets 901-903, which total k packets in this example. Further in this example, the first device and the second device have negotiated to determine that the quantity of data packets to be acknowledged is k. The second device may then transmit acknowledgment packet 911 to acknowledge the k packets 901-903.

In some embodiments, the negotiated quantity of data packets to be acknowledged may be different for the UL than for the DL.

Further in this example, the second device (i.e., the device transmitting on the UL) is configured to transmit data packets as well. Therefore, the second device transmits data packets 912-914, totaling k packets. In response, the first device transmits acknowledgment packet 904, which acknowledges the k packets 912-914.

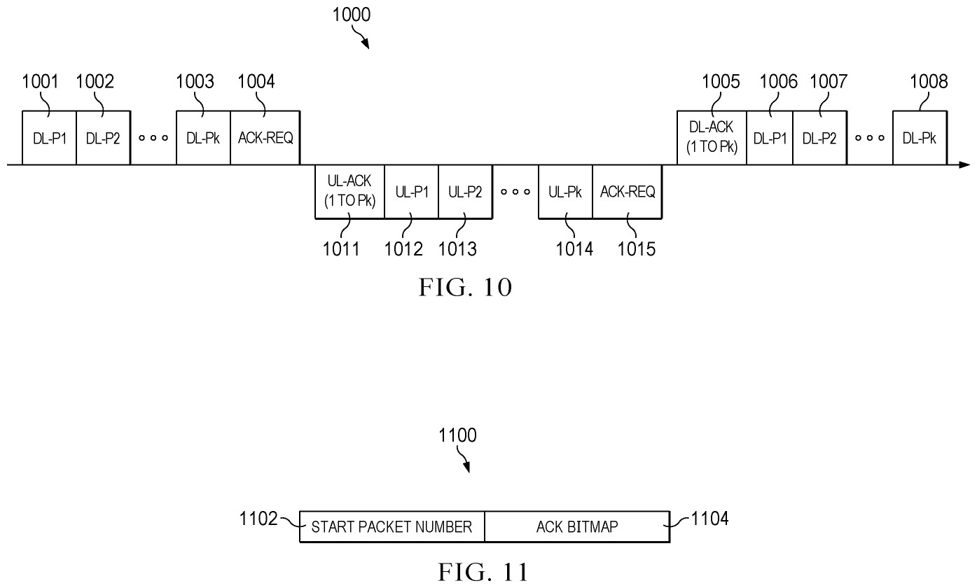

FIG. 10 is an illustration of an example time domain operation 1000, according to various embodiments. In the example of FIG. 10, the acknowledgment mode is a multi-packet acknowledgment mode. Furthermore, while operation 1000 is illustrated using aggregated packets, other embodiments may include performing the same type of acknowledgment while including inter-frame spacing.

In the example of FIG. 10, the first and second device have negotiated to determine that the quantity of data packets to be acknowledged in a single acknowledgment packet is N, where N is larger than k. The first device transmits k data packets 1001-1003 and then transmits an acknowledgment request packet 1004. In response, the second device transmits acknowledgment packet 1011, which acknowledges k data packets 1001-1003.

The second device is configured to transmit data packets as well, as illustrated by data packets 1012-1014 which total to k UL data packets followed by acknowledgment request packet 1015. In response to acknowledgment request packet 1015, the first device transmits acknowledgment packet 1005, which acknowledges k packets 1012-1014. Operation 1000 may go on and on, with the first device transmitting data packets 1006-1008. Should the first device transmit N data packets, then the second device may then acknowledge all N data packets using a single acknowledgment packet. On the other hand, should the first device transmit k packets followed by an acknowledgment request packet, then the second device may acknowledge k data packets using a single acknowledgment packet.

In some implementations of operations 900 and 1000, the second device may conform to a protocol that requires the second device to request time domain and frequency domain resources to transmit data packets 912-914 and 1012-1014. In some such instances, the second device may include a request to transmit data packets in respective acknowledgment packets 911 and 1011. Specifically, various implementations may employ one or more bits within acknowledgment packets 911 and 1011 to signal a request to transmit data packets. The same is true for operations 400 and 600 as well. In other words, a request to transmit may be included in an acknowledgement packet whether or not inter-frame spacing is omitted.

In some embodiments, the negotiated quantity of data packets to be acknowledged may be different for the UL than for the DL.

Some embodiments, in one of the acknowledgment modes of operation, may not negotiate a predetermined quantity of data packet to be acknowledged, and, instead, may use the acknowledgement request packet as a trigger for providing the acknowledged, e.g., with the device providing the acknowledgement acknowledging all packets received since the last acknowledgement provided. Some such embodiments may advantageously allow for increasing throughput, e.g., in applications in which lost of packets can be sustained.

FIG. 11 is an illustration of an example packet payload 1100 that may be used during negotiation, according to various embodiments. For instance, the packet payload 1100 may be accompanied by a packet header (not shown) and transmitted from a first device to a second device to negotiate use of multi-packet acknowledgment techniques.

Packet payload 1100 includes a start packet number portion 1102 and an acknowledgment bitmap portion 1104. The start packet number portion 1102 may indicate a starting index (or other identifier) of a set of to-be-transmitted data packets. As noted above, some implementations may include indexes in the packets, where those indexes are sequence numbers for the packets, each packet having its own sequence number (e.g., embedded in the respective header or payload). The start packet number portion 1102 indicates to the second device to begin using multi-packet acknowledgment beginning at the packet number indicated in portion 1102.

Continuing with the example, the acknowledgment bitmap portion 1104 may set a blank bitmap to indicate to the second device the format of a bitmap for acknowledgment packets. In one example, the negotiations may include setting 10 as a quantity of data packets to be acknowledged by a single acknowledgment packet. In such an example, the acknowledgment bitmap portion 1104 may have 10 zeros or 10 ones to indicate to the second device to populate a bitmap having a 10-bit string. Of course, the scope of implementations is not limited to any particular technique to indicate how to format a bitmap. For example, in some embodiments, the format of the bitmap may be predetermined (e.g., by design).

Continuing with the example, looking at the example of FIG. 3, acknowledgment packet 308 may acknowledge data packets 302-306 by populating a bitmap. For instance, if the acknowledgment bitmap portion 1104 instructs a 5-bit bitmap, and k is equal to 5, then acknowledgment packet 308 may indicate successful acknowledgment of data packets 302-306 by including in its payload [1111]. Additionally, each of the k data packets may include an index (sequence number), each sequence number corresponding to one of the bits in the bitmap. For instance, five sequential packets may have respective indices as follows: [000], [001], [010], [011], [100]. The second device may parse the respective indices from the received data packets and populate the bitmap accordingly.

In an example in which one of the packets is not successfully received, the bitmap may indicate as such. For instance, if the data packet having the index [010] is not successfully received, then the bitmap may indicate [11011].

In another example, the data packets may not have indices. Rather, an acknowledgment packet may simply indicate a number of packets received. For instance, continuing with the example in which k is five, should the second device receive five data packets, then it may generate acknowledgment packet 308 to indicate five packets received. On the other hand, should only four packets be received, and a timeout period has passed, then the second device may generate acknowledgment packet 308 to indicate only four packets received. The first device may interpret an acknowledgment of five packets as being successful for all five packets, whereas the first device may interpret an acknowledgment of only four packets as a failure of at least one packet. While the examples are discussed with respect to FIG. 3, it is understood that the implementations using numbered packets and using non-numbered packets may be applied as appropriate to any implementation, such as any of FIGS. 3-10, 12-13.

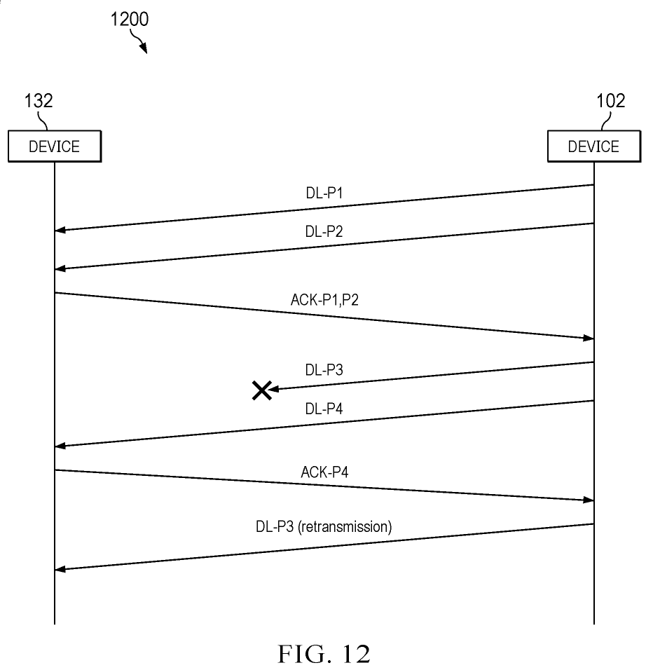

FIG. 12 is an illustration of a signal diagram of an example method 1200 for providing multi-packet acknowledgment and retransmission, according to various embodiments. Example method 1200 illustrates device 102 (FIG. 1) transmitting data packets to device 132, which provides acknowledgment packets. However, it is noted that the roles may be reversed in some instances because the various actions may be performed by either or both of a central device or a peripheral device.

The device 102 transmits data packets P1, P2 to the device 132. In this example, the devices 102, 132 have negotiated multi-packet acknowledgment and have determined that the number of data packets to be acknowledged by a single acknowledgment packet is two. Therefore, after receiving two DL data packets (P1, P2), device 132 generates an acknowledgment packet (ACK-P1, P2) and transmits the acknowledgment packet to device 102. The acknowledgment packet acknowledges receipt of both data packets P1, P2.

After having received the acknowledgment packet, device 102 transmits two more DL data packets P3, P4 to device 132. However, packet P3 is lost in this example so that only packet P4 is received by device 132. From the perspective of device 132, it has received packet P4 but it has reached a timeout without having received a second packet. Therefore, device 132 transmits an acknowledgment packet (ACK-P4), which acknowledges data packet P4 but does not acknowledge data packet P3. The acknowledgment packet ACK-P4 (which may be triggered by the packet number of packet DL-P4 or by a timeout, for example) may indicate P3 negatively (e.g., by bitmap) or may simply omit reference to P3. Device 102 may interpret the acknowledgment packet ACK-P4 to indicate packet loss of data packet P3. Therefore, device 102 performs retransmission of data packet P3. Although not explicitly shown in FIG. 12, device 132 may then acknowledge receipt of packet P3 after retransmission.

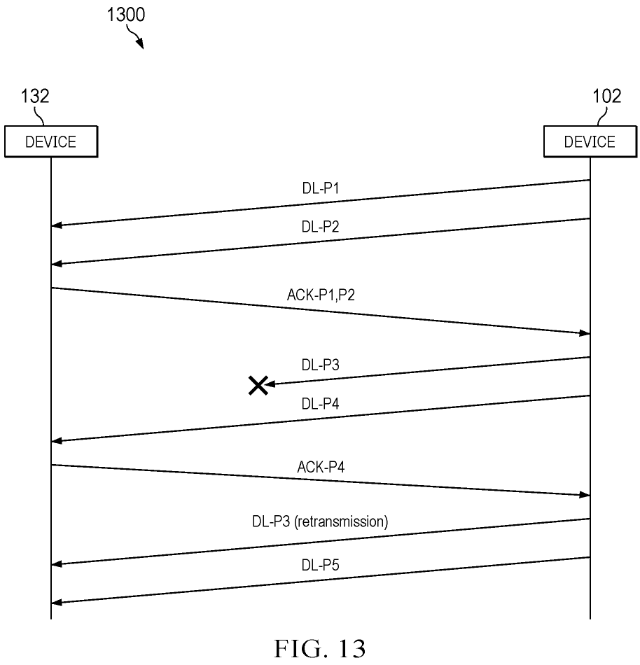

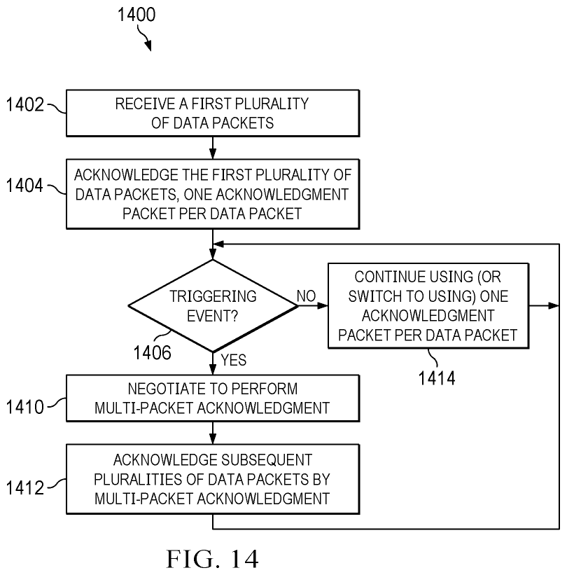

FIG. 13 is an illustration of a signal diagram of an example method 1300 for providing multi-packet acknowledgment and retransmission, according to various embodiments. Example method 1300 is substantially the same as example method 1200 until the retransmission of data packet P3. Example method 1300 is provided to illustrate a sliding window mechanism that allows retransmission of a lost data packet as well as sending a new data packet together in a single event to be acknowledged by the receiving device.

In example method 1300, device 132 has acknowledged receipt of data packet P4 by generating and transmitting acknowledgment packet ACK-P4. The acknowledgment packet ACK-P4 may indicate P3 negatively (e.g., by bitmap) or may simply omit reference to P3. Device 102 interprets the acknowledgment packet ACK-P4 as indicating packet loss of data packet P3. In response, the device 102 retransmits data packet P3 and further transmits data packet P5. Therefore, device 132 has received data packets P3, P5, and, though not explicitly shown, device 132 may then generate and transmit to device 102 a further acknowledgment packet ACK-P3, P5. The further acknowledgment packet acknowledges successful reception of both data packets P3, P5.

FIG. 14 is an illustration of an example method 1400, for providing multiple modes of acknowledgment, according to various embodiments. Example method 1400 may be performed by a processor, such as implemented on a semiconductor die, as the processor executes computer-executable code that it reads from non-transitory computer-readable media. Examples of devices that may perform example method 1400 include devices 102 (e.g., using 108 or 120), and 132 (e.g., using 138 or 150) of FIG. 1, which include respective link layers 124, 154, the link layers being responsible for packet generation and packet acknowledgment.

At action 1402, the first device receives a first plurality of data packets from a second device. At action 1404, the first device acknowledges the first plurality of data packets, one acknowledgment packet per data packet (per-packet acknowledgement mode). An example is shown at FIG. 2, wherein a single data packet 202 is acknowledged by a single acknowledgment packet 204. In one example of method 1400, an acknowledgment mode that uses one acknowledgment packet per data packet may be a default.

At action 1406, the first device determines whether a triggering event has occurred. In one example, the first device determines a quality of a communication link between the first device and the second device. For instance, a quality of a communication link may be given by bit error rate (BER), where a lower bit error rate indicates a higher communication link quality, a received signal strength indicator (RSSI), where a higher RSSI indicates a higher communication link quality, and/or a signal-to-noise ratio (SNR), where a higher SNR indicates a higher communication link quality. Of course, the scope of implementations may be adapted to use any parameter (or a combination therefor) as appropriate. For instance, a parameter may include throughput of the communication link or even a parameter unrelated to the communication link.

Action 1406 may include the first device comparing a value of a parameter to a threshold to determine whether the triggering event has occurred. For instance, a value of BER may be compared to a threshold, and a value of BER lower than the threshold may indicate a higher communication link quality. By contrast, a value of RSSI or SNR that is above a threshold may indicate a higher communication link quality. A throughput either above or below a threshold may be determined at action 1406 and may be considered a triggering event. The threshold may be predetermined by, e.g., being preprogrammed into memory or registers of the first device. The threshold may be preprogrammed, e.g., based on historical data or other appropriate data, and may be preprogrammed, e.g., by an administrator or an application.

Assuming that the value of the parameter compared to the threshold indicates a triggering event at action 1408, then method 1400 moves to actions 1410, 1412, in which the first device switches from using the first acknowledgment mode to using a second acknowledgment mode (e.g., a multi-packet acknowledgment mode). However, if the value of the parameter compared to the threshold does not indicate a triggering event at action 1406, then the first device may continue using the per-packet acknowledgment mode at action 1414. Additionally or alternatively, the triggering event may include a command from a higher layer (e.g., an application layer) to switch from one acknowledgment mode to another.

At action 1410, the first device negotiates with the second device to perform multi-packet acknowledgment. Either the first device or the second device may send a packet, such as the packet illustrated in FIG. 11 to specify a packet identifier (e.g., index) for starting multi-packet acknowledgment and a bitmap format. In some examples, either the first device or the second device may negotiate without assuming that packets are numbered. In some examples, the format may be predetermined (e.g., by design).

Negotiation at action 1410 may include negotiating for use of inter-frame spacing versus omitting inter-frame spacing, such as using aggregated packets. Examples of aggregated packets are shown in FIGS. 7-10. Negotiation may also include negotiating to determine a quantity of data packets to be acknowledged by a single acknowledgment packet. Negotiation may also include allowing or not allowing transmission of an acknowledgement request packet. Negotiation may also include the format of the acknowledgement (e.g., using bitmap, referring to missing or received packets by number, not using numbered packets, etc.).

Once the details of acknowledgment have been determined at action 1410, then the first device and the second device may switch to using multi-packet acknowledgment. From the point of view of the first device, this may include receiving a subsequent plurality of data packets and then acknowledging multiple ones of the subsequent plurality of data packets using a single acknowledgment packet. Examples of multi-packet acknowledgment are described in more detail with respect to FIGS. 3-10, 12-13.

As the first device continues to operate, it may once again determine whether a triggering event has occurred (or not) at action 1406. The first device may then select either the first acknowledgment mode (one acknowledgment packet per data packet) or the second acknowledgment mode (a multi-packet acknowledgment mode) based on action 1406. In fact, the first device may operate over a period of time and may switch between a default first mode and a multi-packet second mode multiple times as the communication link changes.

Although FIG. 14 illustrates a device having two modes of acknowledgement, in some embodiments, a device may implement more than 2 modes of acknowledgment, such as 3 or more. For example, a first mode may be the per-packet mode, a second mode may be a multi-packet mode, and a third mode may rely solely on acknowledgement request packets without sending an acknowledgement packet unless triggered by an acknowledgement request packet, and which may acknowledge 1 or more packets received, depending on the circumstance, which may vary over time.

Various embodiments may include advantages over other solutions. For instance, the embodiment of FIG. 14 includes the action 1406, which measure a communication link quality, analyze the link quality, and select a communication mode based at least in part on that link quality. Accordingly, some such embodiments may use multi-packet acknowledgment to increase throughput at times when the communication link is reliable enough to handle the increased throughput. Furthermore, such embodiments may avoid overhead associated with timeouts by using an acknowledgment mode having one acknowledgment packet per data packet when the communication link is less reliable.

Additionally, as noted above, the multi-packet acknowledgment of action 1412, all things being equal, may reduce overhead and thus provide higher throughput than would generally be expected by using one acknowledgment packet per data packet. Examples of applications that may benefit from increased throughput include, but are not limited to, vehicular applications, logical link control and adaptation protocol (L2CAP) connection-oriented channel (CoC) applications, and the like. For instance, an automotive application employing Channel Sounding may benefit from increased throughput. Additionally, an automotive Digital Key, which may transmit (e.g., from a vehicle to a smartphone or key fob) a relatively large amount of data in a short amount of time, may benefit from increased throughput.

In some embodiments, the negotiated number of packets (e.g., action 1410) may be changed over time, e.g., based on communication quality or other factors, and may be different between UL and DL. For example, some embodiments (during action 1410) may select ka as the negotiated packet quantity if the communication quality is higher than Qa and lower than Qb, and may select kb as the negotiated packet quantity if the communication quality is higher than Qb, where kb is higher than ka, and where Qb represents a higher communication quality than Qa.

In some embodiments, action 1410 may be performed at any appropriate time, such as before a data exchange, during a data exchange, before a (e.g., BLE) connection event, during a (e.g., BLE) connection event, when a device joins the network, and/or at any other suitable time.

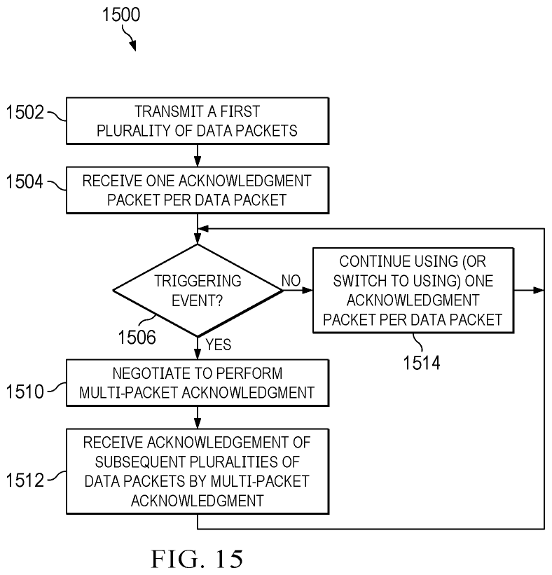

FIG. 15 is an illustration of an example method 1500, for providing multiple modes of acknowledgment, according to various embodiments. Example method 1500 may be performed by a processor, such as implemented on a semiconductor die, as the processor executes computer-executable code that it reads from non-transitory computer-readable media. Examples of devices that may perform example method 1500 include devices 102 (e.g., using 108 or 120), and 132 (e.g., using 138 or 150) of FIG. 1, which include respective link layers 124, 154, the link layers being responsible for packet generation and packet acknowledgment.

Method 1500 of FIG. 15 operates in a similar manner as method 1400 of FIG. 14, but differs by being performed by a device that transmits data packets and receives acknowledgment packets. FIG. 15 is offered to demonstrate that link quality measurement, link quality analysis, (or other parameter measurement and analysis) and selection of an acknowledgment mode may be performed by a device that transmits data packets and receives acknowledgment packets.

At action 1502, the first device transmits a plurality of data packets. At action 1504, the first device receives one acknowledgment packet per data packet. An example is shown above with respect to FIG. 2.

Actions 1506 and 1510 are the same as or similar to actions 1406 and 1410 of FIG. 14. Assuming that the link quality passes at action 1508, then the second mode of acknowledgment includes receiving acknowledgment of subsequent pluralities of data packets by multi-packet acknowledgment at action 1512. Multi-packet acknowledgment examples are given above with respect to FIGS. 3-10, 12-13. Assuming that the link quality does not pass at action 1508, then the first device continues to receive acknowledgments one acknowledgment packet per data packet at action 1514.

Just as at method 1400, at method 1500, the first device may measure link quality and determine to use the first acknowledgment mode or the second acknowledgment mode as appropriate.

Example embodiments of the present disclosure are summarized here. Other embodiments can also be understood from the entirety of the specification and the claims filed herein.

Example 1. A method including: receiving, at a first device, a first plurality of packets from a second device; acknowledging, by the first device, the first plurality of packets, including transmitting to the second device a first plurality of acknowledgment packets, one acknowledgment packet per data packet; determining that a triggering event has occurred; and negotiating to perform multi-packet acknowledgment between the first device and the second device in response to the triggering event.

Example 2. The method of example 1, where a first acknowledgment packet of the first plurality of acknowledgment packets includes a non-empty data packet.

Example 3. The method of one of examples 1, where a first acknowledgment packet of the first plurality of acknowledgment packets includes an empty packet.

Example 4. The method of one of examples 1 to 3, where a number of bits of the empty packet is 10 octets.

Example 5. The method of one of examples 1 to 4, where determining that the triggering event has occurred includes determining that a quality of a communication link between the first device and the second device is above a predetermined threshold.

Example 6. The method of one of examples 1 to 5, where the predetermined threshold is a signal-to-noise ratio (SNR) threshold associated with the communication link, and where negotiating to perform multi-packet acknowledgment with the second device includes negotiating to perform multi-packet acknowledgment with the second device in response to an SNR associated with the first plurality of packets being higher than the SNR threshold.

Example 7. The method of one of examples 1 to 5, where the predetermined threshold is a received signal strength indicator (RSSI) threshold, and where negotiating to perform multi-packet acknowledgment with the second device includes negotiating to perform multi-packet acknowledgment with the second device in response to an RSSI associated with the first plurality of packets being higher than the RSSI threshold.

Example 8. The method of one of examples 1 to 5, where the predetermined threshold is a bit error rate (BER) threshold, and where negotiating to perform multi-packet acknowledgment with the second device includes negotiating to perform multi-packet acknowledgment with the second device in response to a BER associated with the first plurality of packets being lower than the BER threshold.

Example 9. The method of one of examples 1 to 8, further including: after negotiating to perform multi-packet acknowledgment, receiving, by the first device, a second plurality of packets from the second device, where the second plurality of packets includes respective unique identifiers for each packet of the second plurality of packets; and transmitting a first acknowledgment packet that acknowledges multiple packets of the second plurality of packets according to the respective unique identifiers.

Example 10. The method of one of examples 1 to 9, further including: determining that a missing packet of the second plurality of packets was not received by the first device based on the unique identifiers of the plurality of packets, and, in response requesting retransmission of the missing packet.

Example 11. The method of one of examples 1 to 10, where transmitting a first acknowledgment packet acknowledges (Ack) or not acknowledges (NACK) each data packet of the second plurality of packets according to the respective unique identifiers.

Example 12. The method of one of examples 1 to 11, where transmitting the first acknowledgement packet includes using a bitmap.

Example 13. The method of one of examples 1 to 12, where transmitting the first acknowledgement packet includes transmitting the first acknowledgement packet along with additional data.

Example 14. The method of one of examples 1 to 13, where the first acknowledgment packet requests transmission of a third plurality of packets from the first device to the second device.

Example 15. The method of one of examples 1 to 14, where the second plurality of packets omits inter-frame spacing.

Example 16. The method of one of examples 1 to 14, where the inter-frame spacing is 150 μs.

Example 17. The method of one of examples 1 to 16, further including: after negotiating to perform multi-packet acknowledgment, begin counting packets in a second plurality of packets; and acknowledging the second plurality of packets, including transmitting a first acknowledgment packet that indicates a number of packets received of the second plurality of packets.

Example 18. The method of one of examples 1 to 17, where the number of packets received is less than a quantity of the second plurality of packets, and where the first acknowledgment packet requests retransmission of a missing packet.

Example 19. The method of one of examples 1 to 18, where the first device includes a central device of a wireless network, where the second device includes a peripheral device of the wireless network, and where the central device transmits an initial packet as part of a communication link between the first device and the second device.

Example 20. The method of one of examples 1 to 18, where the first device includes a peripheral device of a wireless network, where the second device includes a central device of the wireless network, and where the central device transmits an initial packet as part of a communication link between the first device and the second device.

Example 21. The method of one of examples 1 to 20, where negotiating to perform multi-packet acknowledgment includes indicating that the first device begin performing multi-packet acknowledgment for subsequent transmissions of packets.

Example 22. The method of one of examples 1 to 21, where indicating that the first device begin performing multi-packet acknowledgment for subsequent transmissions of packets includes requesting that the first device perform multi-packet acknowledgement for every N packets received, N being a positive integer greater than 1.

Example 23. The method of one of examples 1 to 22, further including: before receiving, by the first device, N packets from a last multi-packet acknowledgement, receiving an early acknowledgement request by the second device; and in response to receiving the early acknowledgement request, providing, by the first device, an acknowledgement packet to acknowledge each packet received from the last multi-packet acknowledgement.

Example 24. The method of one of examples 1 to 23, where negotiating to perform multi-packet acknowledgment includes determining a quantity of packets to be acknowledged with a single acknowledgment packet, the method further including: receiving a second plurality of packets from the second device, where the second plurality of packets is less than the quantity; receiving a request from the second device to acknowledge the second plurality of packets; and transmitting a first acknowledgment packet to the second device, where the first acknowledgment packet acknowledges only the second plurality of packets.

Example 25. The method of one of examples 1 to 24, where a first acknowledgment packet of the first plurality of acknowledgment packets includes an empty packet, the method further including: after negotiating to perform multi-packet acknowledgment, receiving, by the first device, a second plurality of packets from the second device; and transmitting a second acknowledgment packet to the second device, where the second acknowledgment packet acknowledges multiple packets within the second plurality of packets, and where the second acknowledgment packet includes a larger quantity of bits than the first acknowledgment packet.

Example 26. The method of one of examples 1 to 25, where a communication link between the first device and the second device is a Bluetooth Low Energy (BLE) communication link.

Example 27. The method of one of examples 1 to 26, where determining that the triggering event has occurred includes determining that a throughput of a communication link between the first device and the second device is above a predetermined threshold.

Example 28. The method of one of examples 1 to 27, where determining that the triggering event has occurred includes determining that an instruction from a higher layer has been received.

Example 29. The method of one of examples 1 to 28, where the first plurality of packets include layer 2 packets transmitted over the air.

Example 30. A method including: transmitting, from a first device, a first plurality of packets to a second device; receiving, by the first device, a first plurality of acknowledgment packets, one acknowledgment packet per data packet, from the second device; determining that a triggering event has occurred; and negotiating to perform multi-packet acknowledgment between the first device and the second device in response to the triggering event.

Example 31. An electronic device including: a transducer configured to communicate via a wireless network; and a processor configured to: operate in a per-packet acknowledgment mode in which the processor transmits, using the transducer, an acknowledgement packet per packet received; and switch from the per-packet acknowledgment mode to a multi-packet acknowledgment mode in which the processor transmits, using the transducer, an acknowledgment packet to acknowledge multiple packets received.

Example 32. The electronic device of example 31, where, during the per-packet acknowledgment mode, the processor is configured to transmit an empty packet as an acknowledgment packet to a first packet received from a first device in response to having no data to transmit to the first device.

Example 33. The electronic device of one of examples 31 or 32, where: during the per-packet acknowledgment mode, the processor is configured to receive a first plurality of packets having inter-frame spacing; and during the multi-packet acknowledgment mode, the processor is configured to receive a second plurality of packets without inter-frame spacing.

Example 34. The electronic device of one of examples 31 to 33, where, the per-packet acknowledgment mode is a default mode.

Example 35. The electronic device of one of examples 31 to 34, where the empty packet includes: a header; cyclic redundancy check (CRC) content; and a payload having no data.

Example 36. The electronic device of one of examples 31 to 35, where the processor is configured to: determine a link quality of a communication link between the electronic device and a first device; and switch to the multi-packet acknowledgement mode in response to the link quality being higher than a predetermined threshold.

Example 37. The electronic device of one of examples 31 to 36, where the processor is configured to: determine a throughput of a communication link between the electronic device and a first device; and switch to the multi-packet acknowledgement mode in response to the throughput being higher than a predetermined threshold.

Example 38. The electronic device of one of examples 31 to 37, where the processor is configured to switch to the multi-packet acknowledgment mode in response to a request from a first device.

Example 39. The electronic device of one of examples 31 to 38, where a first acknowledgement packet in the multi-packet acknowledgement mode includes a payload having a bitmap that corresponds to a plurality of received uniquely identified packets.

Example 40. The electronic device of one of examples 31 to 39, where a first acknowledgement packet in the multi-packet acknowledgement mode includes a payload indicating a quantity of packets received from a first device.

Example 41. The electronic device of one of examples 31 to 40, where, during the multi-packet acknowledgement mode, the processor is configured to: receive multiple packets having no inter-frame spacing.

Example 42. The electronic device of one of examples 31 to 41, where, during the multi-packet acknowledgement mode, the processor is configured to: generate a first acknowledgment packet in response to receiving an acknowledgment request.

Example 43. The electronic device of one of examples 31 to 42, where the electronic device includes a sensor device.

Example 44. The electronic device of one of examples 31 to 43, where the electronic device includes a vehicle or key fob.

Example 45. The electronic device of one of examples 31 to 44, where the electronic device is configured to operate as a reflector device during channel sounding.

Example 46. The electronic device of one of examples 31 to 45, where, during the multi-packet acknowledgement mode, the processor is configured to communicate with a first device using a logical link control and adaptation protocol (L2CAP).

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims.

What is claimed is:

1. A method comprising:
receiving, at a first device, a first plurality of packets from a second device;
acknowledging, by the first device, the first plurality of packets, including transmitting to the second device a first plurality of acknowledgment packets, one acknowledgment packet per data packet;
determining that a triggering event has occurred; and
negotiating to perform multi-packet acknowledgment between the first device and the second device in response to the triggering event.

2. The method of claim 1, wherein a first acknowledgment packet of the first plurality of acknowledgment packets comprises a non-empty data packet.

3. The method of claim 1, wherein a first acknowledgment packet of the first plurality of acknowledgment packets comprises an empty packet.

4. The method of claim 3, wherein a number of bits of the empty packet is 10 octets.

5. The method of claim 1, wherein determining that the triggering event has occurred includes determining that a quality of a communication link between the first device and the second device is above a predetermined threshold.

6. The method of claim 5, wherein the predetermined threshold is a signal-to-noise ratio (SNR) threshold associated with the communication link, and wherein negotiating to perform multi-packet acknowledgment with the second device comprises negotiating to perform multi-packet acknowledgment with the second device in response to an SNR associated with the first plurality of packets being higher than the SNR threshold.

7. The method of claim 5, wherein the predetermined threshold is a received signal strength indicator (RSSI) threshold, and wherein negotiating to perform multi-packet acknowledgment with the second device comprises negotiating to perform multi-packet acknowledgment with the second device in response to an RSSI associated with the first plurality of packets being higher than the RSSI threshold.

8. The method of claim 5, wherein the predetermined threshold is a bit error rate (BER) threshold, and wherein negotiating to perform multi-packet acknowledgment with the second device comprises negotiating to perform multi-packet acknowledgment with the second device in response to a BER associated with the first plurality of packets being lower than the BER threshold.

9. The method of claim 1, further comprising:
after negotiating to perform multi-packet acknowledgment, receiving, by the first device, a second plurality of packets from the second device, wherein the second plurality of packets includes respective unique identifiers for each packet of the second plurality of packets; and
transmitting a first acknowledgment packet that acknowledges multiple packets of the second plurality of packets according to the respective unique identifiers.

10. The method of claim 9, further comprising:
determining that a missing packet of the second plurality of packets was not received by the first device based on the unique identifiers of the plurality of packets, and, in response requesting retransmission of the missing packet.

11. The method of claim 9, wherein transmitting a first acknowledgment packet acknowledges (Ack) or not acknowledges (NACK) each data packet of the second plurality of packets according to the respective unique identifiers.

12. The method of claim 9, wherein transmitting the first acknowledgement packet comprises using a bitmap.

13. The method of claim 9, wherein transmitting the first acknowledgement packet comprises transmitting the first acknowledgement packet along with additional data.

14. The method of claim 9, wherein the first acknowledgment packet requests transmission of a third plurality of packets from the first device to the second device.

15. The method of claim 9, wherein the second plurality of packets omits inter-frame spacing.

16. The method of claim 1, further comprising:
after negotiating to perform multi-packet acknowledgment, begin counting packets in a second plurality of packets; and
acknowledging the second plurality of packets, including transmitting a first acknowledgment packet that indicates a number of packets received of the second plurality of packets.

17. The method of claim 16, wherein the number of packets received is less than a quantity of the second plurality of packets, and wherein the first acknowledgment packet requests retransmission of a missing packet.

18. The method of claim 1, wherein the first device comprises a central device of a wireless network, wherein the second device comprises a peripheral device of the wireless network, and wherein the central device transmits an initial packet as part of a communication link between the first device and the second device.

19. The method of claim 1, wherein the first device comprises a peripheral device of a wireless network, wherein the second device comprises a central device of the wireless network, and wherein the central device transmits an initial packet as part of a communication link between the first device and the second device.

20. The method of claim 1, wherein negotiating to perform multi-packet acknowledgment comprises indicating that the first device begin performing multi-packet acknowledgment for subsequent transmissions of packets.

21. The method of claim 20, wherein indicating that the first device begin performing multi-packet acknowledgment for subsequent transmissions of packets comprises requesting that the first device perform multi-packet acknowledgement for every N packets received, N being a positive integer greater than 1.

22. The method of claim 21, further comprising:
before receiving, by the first device, N packets from a last multi-packet acknowledgement, receiving an early acknowledgement request by the second device; and
in response to receiving the early acknowledgement request, providing, by the first device, an acknowledgement packet to acknowledge each packet received from the last multi-packet acknowledgement.

23. The method of claim 1, wherein negotiating to perform multi-packet acknowledgment comprises determining a quantity of packets to be acknowledged with a single acknowledgment packet, the method further comprising:
receiving a second plurality of packets from the second device, wherein the second plurality of packets is less than the quantity;
receiving a request from the second device to acknowledge the second plurality of packets; and
transmitting a first acknowledgment packet to the second device, wherein the first acknowledgment packet acknowledges only the second plurality of packets.

24. The method of claim 1, wherein a first acknowledgment packet of the first plurality of acknowledgment packets comprises an empty packet, the method further comprising:
after negotiating to perform multi-packet acknowledgment, receiving, by the first device, a second plurality of packets from the second device; and
transmitting a second acknowledgment packet to the second device, wherein the second acknowledgment packet acknowledges multiple packets within the second plurality of packets, and wherein the second acknowledgment packet includes a larger quantity of bits than the first acknowledgment packet.

25. The method of claim 1, wherein a communication link between the first device and the second device is a Bluetooth Low Energy (BLE) communication link.

26. The method of claim 1, wherein determining that the triggering event has occurred includes determining that a throughput of a communication link between the first device and the second device is above a predetermined threshold.

27. The method of claim 1, wherein determining that the triggering event has occurred includes determining that an instruction from a higher layer has been received.

28. The method of claim 1, wherein the first plurality of packets comprise layer 2 packets transmitted over the air.
